(19) United States
(12) Patent Application Publication
(10) Pub. No.: US 2006/0049684 A1
(43) Pub. Date: Mar. 9, 2006

(54) Visually enhancing rotating addition for a wheel

(76) Inventors: Erik Wayne Johnson, Roseville, MN (US); Michael William Fynboh, Winsted, MN (US)

Correspondence Address: MIKE W. FYNBOH AND;ERIK W. JOHNSON, 2906 OLD HIGHWAY 8, ROSEVILLE, MN, 55113, US

(21) Appl. No.: 10/711,292

(22) Filed: Sep. 8, 2004

(51) Int. Cl. B60B 7/04

(52) U.S. Cl. 301/37.25

(57) ABSTRACT

The current invention pertains to an apparatus that is a rotary addition adaptable to, for example, wheel rims for motor vehicles. The device includes a rotary base that is coupled to the rim of a wheel for the intent of rotation of a secondary rotating section. The rotating section would be coupled to the rotary base allowing itself to rotate with or without a delayed reaction dependant on the rotation of the wheel rim. The apparatus could also be capable of rotating in the counter direction of the wheel rim with or without a delayed reaction dependent on the rotation of the wheel rim.

### TECHNICAL FIELD

The invention pertains to the general field of Class 301: Land Vehicles: Wheels and Axels and more specifically to that pertaining to Subclass 5.1: Wheels.

### BACKGROUND

Vehicles are being altered to make them more visually attractive for social, monetary and aesthetic reasons. One specific and relatively easy area of this alteration is in the area of wheels. The counterintuitive motion of the rotating section with the present invention draws attention to the accessory thereby creating an increased social and aesthetic presence while increasing the monetary value of the vehicle.

Previous patents pertaining to wheel enhancements have focused on an image or design of a wheel to give a certain effect achieved when they rotate at the same rate as that of the entire wheel. Such as in U.S. Pat. No. 5,931,543 and U.S. Pat. No. 6,464,303. Other patents pertaining to wheel enhancements have focused on a portion of the wheel with the ability to spin free of the wheel allowing it to stay static in relation to the surroundings even while the wheel itself rotates. This is achieved by weighting that portion to inhibit rotation, thus causing the portion to contain a design in a set orientation independent of the wheel position and/or rotation. Such as in U.S. Pat. No. 6,471,302. The present patent differs from both of these ideas in the fact that the rotation of the rotating section is not independent of rotation, does not always move at the same speed as the wheel rotation, and not necessarily in the same direction. Rather, the rotating section is influenced by the retardant transfer of rotational kinetic energy to the rotating section through the application of a bearing system and a sprocket system that would yield counter rotation.

### SUMMARY OF INVENTION

The invention is a visually enhancing rotating portion of a wheel that counter rotates due to a transfer of rotational kinetic energy transferred through a bearing system along with a sprocket system from a rotating wheel. The wheelbase will have an attached system of sprockets that enable the outer rotating section to spin in the opposite direction than the direction of the rotating wheelbase. The rotational kinetic energy of the rotating wheelbase will be transferred, through a system of sprockets, to an outer rotating section. The result will be the appearance of wheels moving in the opposite direction than the vehicle is/was moving.

The rotational kinetic energy transfer to give a delayed reaction is accomplished using a bearing system that, in its nature, is not a direct connection and therefore does not allow for an immediate transfer of energy. Rather, the energy to achieve full rotational velocity of the rotating section is achieved slower due to frictional forces within the bearing system. If a rotational velocity difference between the rotary base and rotating section occurs for a sufficient amount of time the difference in velocity will continue to decrease until the rotating section reaches a rotational velocity equal to that of the rotary base. When the rotary base starts to decrease in velocity the same phenomenon will occur where the rotating section continues to spin faster than the rotary base until frictional forces reduce the speed of the rotating section until it equals that of the rotary base. The rotating section can take any form so as to give different visual effects. The rotating section can be weighted in different ways (different weights, different configurations, etc.) such that the rate of rotational kinetic energy transfer is either increased or decreased. The weighting of the rotational section should be in a way that will not inhibit rotation completely.

The sprocket system will enable the rotating section to spin in the opposite direction than the rotary base is moving. The bearing system will enable the rotating section to have a delayed reaction from the rotary base. The sprocket system combined with the bearing system will enable the overall invention to create a rotating section that is spinning in the opposite direction than the rotary base with a reaction that is delayed from the rotary base.

### BRIEF DESCRIPTION OF THE DRAWINGS

FIG. 1. Shows a cross sectional view as described in claim 1 with an optional rotary base configuration that is perimeter reaching

FIG. 1-A Shows the cross sectional view of the rotary base section on FIG. 1.

FIG. 1-B Shows the cross sectional view of the rotating section on FIG. 1.

FIG. 2. Shows a cross sectional view as described in claim 1 with an optional rotary base configuration that is centrally attached.

FIG. 2-A Shows the cross sectional view of the rotary base section on FIG. 2.

FIG. 2-B Shows the cross sectional view of the rotating section on FIG. 2.

FIG. 3. Shows a cross sectional view as described in claim 2.

FIG. 3-A. Shows the cross sectional view of the rotary base section on FIG. 3.

FIG. 3-B-Side Shows the cross sectional/side view as described in claim 3.

FIG. 3-B-Front Shows the Front view as described in claim 3.

FIG. 3-C. Shows the cross sectional view of the rotating section on FIG. 3.

### DETAILED DESCRIPTION OF THE INVENTION

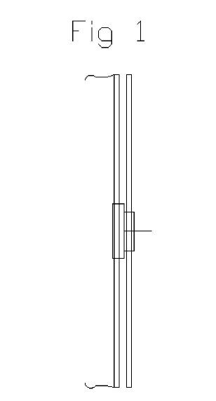

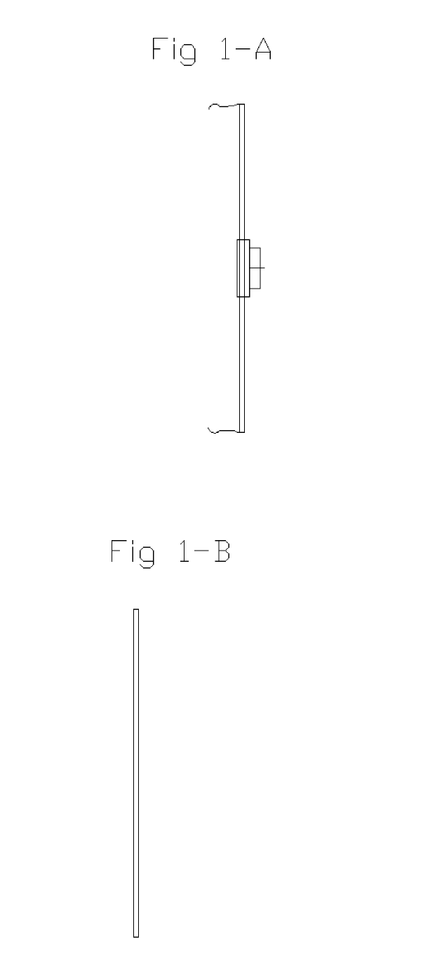

The center point of FIG. 1-B is arranged at the center point of FIG. 1-A to constitute FIG. 1 as one unit.

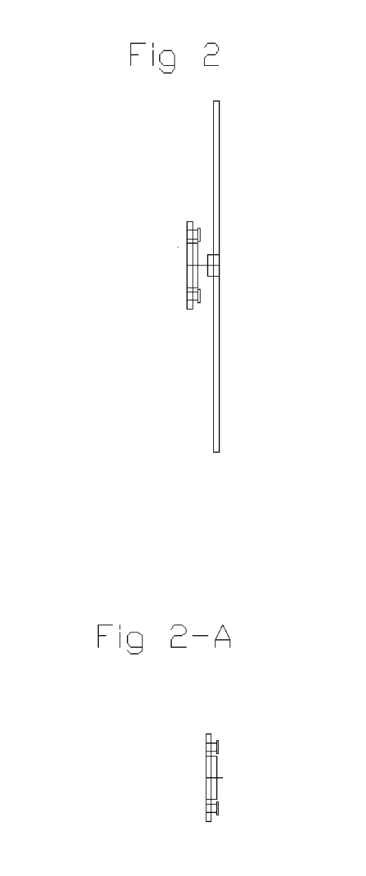

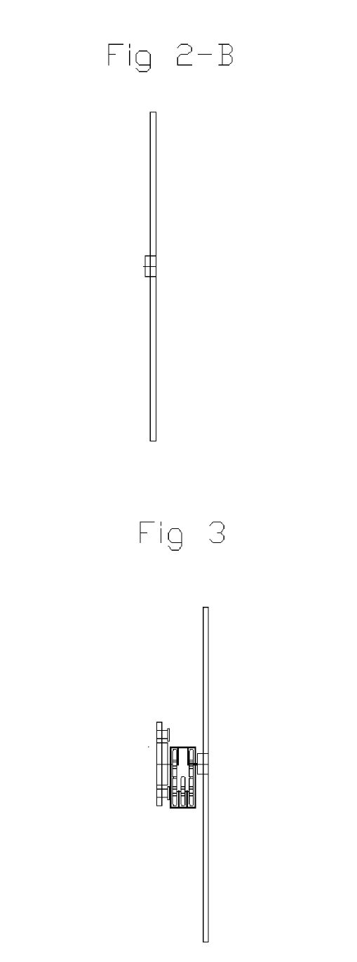

The center point of FIG. 2-B is arranged at the center point of FIG. 2-A to constitute FIG. 2 as one unit.

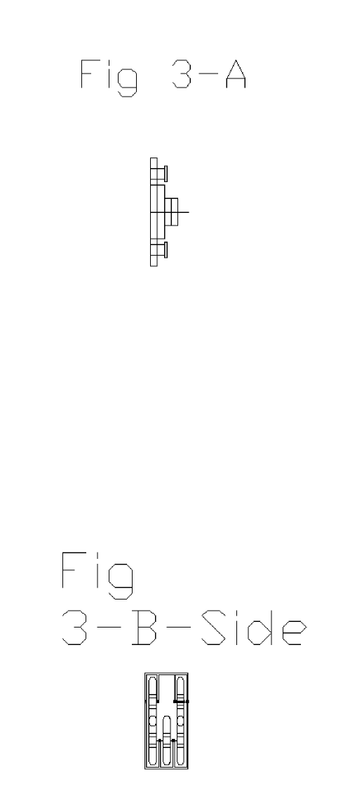

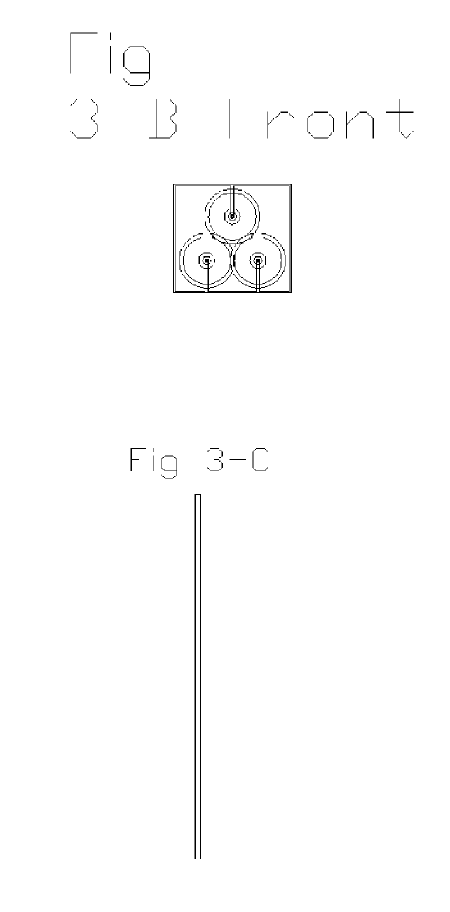

The center point of FIG. 3-C is arranged at the center point of FIG. 3-A with 3-B-Side fitting in the middle to constitute FIG. 3 as one unit.

What is claimed is:

1. Visually enhancing rotating addition for a wheel coupled to a wheel rim through a rotary base with the intent to cover and disguise or enhance the wheel rim itself.

2. Visually enhancing counter rotating addition for a wheel coupled to a wheel rim through a rotary base containing a rotation inversion portion with the intent to rotate the rotating addition in the opposite direction of the rotation of the wheel rim itself.

3. Rotation inversion portion that will take rotation of a shaft secured in both location and rotation at the centerline of the wheel rim and produce a counter rotation to a rotating addition section.

4. Visually enhancing rotating addition for a wheel as claimed in claim 1. The rotary base will consist of a bearing system that is connected to the rim itself. Said bearing system will be stationary with respect to the wheel rim while said rotating section will rotate with a delayed reaction dependent on the rotation of the wheel rim.

5. Visually enhancing rotating addition for a wheel as claimed in claim 1. The rotating section will consist of a decorative piece that will rotate with delayed reaction dependent on the rotation of the wheel rim as previously stated. The piece can take any form so as to give a visually enhanced effect using, but not limited to, shape and/or reflectivity and/or color in conjunction with the delayed rotation effect.

6. Visually enhancing rotating addition for a wheel as claimed in claim 1. The bearing system portion of the rotary base will act as a retardant to kinetic energy transfer giving a delayed kinetic energy transfer to the said rotating section.

7. Visually enhancing rotating addition for a wheel as claimed in claim 1. The rotary base could act as a barrier between the brakes and the rotating section. The barrier would inhibit brake dust from forming on the outside of the rotating section and thus reduce the need for cleaning.

8. Visually enhancing rotating addition for a wheel as claimed in claim 1. The rotating section will be weighted such that changing the weight amount and/or the weight configuration will affect the delayed transfer of kinetic energy in differing ways.

9. Visually enhancing counter rotating addition for a wheel as claimed in claim 2. The rotary base will consist of a sprocket system that is connected to the rim itself. Said sprocket system will be as a unit stationary with respect to the ground while said rotating section will counter rotate dependent on the rotation of the wheel rim.

10. Visually enhancing counter rotating addition for a wheel as claimed in claim 2. The rotating section will consist of a decorative piece that will counter rotate dependent on the rotation of the wheel rim as previously stated. The piece can take any form so as to give a visually enhanced effect using, but not limited to, shape and/or reflectivity and/or color in conjunction with the delayed rotation effect.

11. Visually enhancing counter rotating addition for a wheel as claimed in claim 2. The rotary base may contain a bearing system that will act as a retardant to kinetic energy transfer giving a delayed kinetic energy transfer to the said rotating section. This will give an overall counter rotation with a delayed reaction.

12. Rotation inversion portion that will take rotation of a shaft secured in both location and rotation at the centerline of the wheel rim and produce a counter rotation as claimed in claim 3. The rotary base will consist of a set of sprockets. The rotation of the wheel rim will be transferred to a sprocket along a shaft. Both sprocket and shaft will be centered along the centerline. A second shaft and sprocket will be tangentially located to the sprocket secured to the wheel rim centerline shaft. The second shaft will then be forced to rotate in a counter direction to the sprocket connected to the shaft at the centerline of the wheel rim. The second shaft will also have a second sprocket that will be secured to the second shaft. This second sprocket on the second shaft will line up tangentially to a sprocket secured to a third shaft. The third shaft, by definition, will be forced to rotate in the counter direction of the second shaft and therefore in the same direction as the wheel rim centerline shaft. The third shaft will have a second sprocket that will line up tangentially to a sprocket attached to a fourth shaft. This fourth shaft will rotate counter of the third shaft that is rotating counter of the second shaft that is rotating counter of the wheel rim centerline shaft. This will give the rotating section a counter rotation to that of the wheel. This configuration does not limit this invention to specific configurations or materials, any type of configuration or material that produces the same effect as described in claim 3 is acceptable.

13. Rotation inversion portion that will take rotation of a shaft secured in both location and rotation at the centerline of the wheel rim and produce a counter rotation as claimed in claim 3. The Rotation inversion portion may also contain a bearing that will allow the final counter rotation to be a delayed reaction dependent on the rotation of the wheel rim.

14. Rotation inversion portion that will take rotation of a shaft secured in both location and rotation at the centerline of the wheel rim and produce a counter rotation as claimed in claim 3. The rotation inversion portion can be weighted in a way as to reduce any motion in reference to the ground. Due to the rotations contained within the rotary base, the rotation inversion portion will tend to rotate itself around the wheel rim centerline. With sufficient weighting, the rotation inversion portion will tend to reside in a mostly stationary state in relation to the wheel rim centerline.

15. Rotation inversion portion that will take rotation of a shaft secured in both location and rotation at the centerline of the wheel rim and produce a counter rotation as claimed in claim 3. The bearing system portion of the rotary base will act as a retardant to kinetic energy transfer giving a delayed kinetic energy transfer to the said rotating section.
